(19) United States
(12) Patent Application Publication
(10) Pub. No.: US 2021/0388862 A1
(43) Pub. Date: Dec. 16, 2021

(54) COTTER PIN WITH SEPARATION PREVENTING MEANS AND METHOD OF MANUFACTURING THE SAME

(71) Applicant: HM CORPORATION, Yangsan-si (KR)

(72) Inventors: Choon Hyun PARK, Yangsan-si (KR); Dae Hoon YOO, Busan (KR); Jung Hyun PARK, Yangsan-si (KR); Gun Tae PARK, Busan (KR)

(73) Assignee: HM CORPORATION

(21) Appl. No.: 17/065,691

(22) Filed: Oct. 8, 2020

Related U.S. Application Data
(63) Continuation of application No. PCT/KR2020/011669, filed on Sep. 1, 2020.

(30) Foreign Application Priority Data
Jun. 10, 2020 (KR) 10-2020-0070146

(51) Int. Cl. F16B 39/04

(52) U.S. Cl. CPC F16B 39/04

(57) ABSTRACT

A cotter pin with a separation preventing means and a method of manufacturing the same are proposed. The method includes a material cutting step, a heating step of heating a preform resulting from cutting, a first shaping step of forming a dome-shaped head at each of opposite ends of the heated preform, a cutting step of forming segmented shaped bodies, a second shaping step of forming a side groove, a third shaping step of forming a lower groove in a lower end of each of the segmented shaped bodies, a through-hole forming step, and a separation preventing means coupling step. Therefore, the present invention has a technical feature that maximizes work efficiency and productivity and provides economic savings by integrating the separation preventing means and the cotter pin, and by simultaneously making manufacturing two cotter pins in a single process cycle.

### REFERENCE TO RELATED APPLICATIONS

This is a continuation of International Patent Application PCT/KR2020/011669 filed on Sep. 1, 2020, which designates the United States and claims priority of Korean Patent Application No. 10-2020-0070146 filed on Jun. 10, 2020, the entire contents of which are incorporated herein by reference.

### FIELD OF THE INVENTION

The present invention relates generally to a cotter pin with a separation preventing means and a method of manufacturing the same. More particularly, the present invention relates to a cotter pin with a separation preventing means and a method of manufacturing the same, wherein the cotter pin used for connection of a suspension insulator in a transmission/distribution line and the like can be improved in strength and productivity.

### BACKGROUND OF THE INVENTION

In general, a cotter pin, which is applied to a suspension insulator of an overhead transmission/distribution line, is made of mild steel formed into a pin shape with an extended head at one end. The cotter pin is installed by the following method. A hole formed in the suspension insulator and a hole formed in a transmission/distribution wire are placed to overlap with each other; the cotter pin is inserted into the overlapped holes so as to pass therethrough; and finally, a split pin is fastened in a direction intersecting the insertion direction of the cotter pin to keep the cotter pin securely in place.

Further, as such installation work of the cotter pin is applied to a high-voltage current transfer facility, operators are required to wear protective insulating gloves for safety. However, in the case of wearing thick protective insulating gloves, difficulties may arise in the installation work as the sense of the operator becomes dull, with a resulting high risk of safety accidents.

In addition, in the case of a structure in which a locking bolt and a cotter pin are separated, there is a high possibility that the operator may lose the cotter pin, and when the cotter pin is removed from the locking bolt for maintenance work, workability may be deteriorated.

Therefore, in an effort to solve the above problems, Korean Patent No. 10-1704932 has disclosed ‘A manufacturing method of a cotter pin shaft’, and Korean Patent No. 10-1791385 has disclosed ‘An integral-type cotter pin manufacturing method’.

The manufacturing method of the cotter pin shaft and the integral-type cotter pin manufacturing method commonly have a structure in which a cotter pin and a separation prevention pin are manufactured through cold forging, and the separation prevention pin is formed integrally with the cotter pin so that the separation prevention can be used immediately after installation of the cotter pin. Therefore, during the connection operation of a suspension insulator, the cotter pin can be easily secured in place in the suspension insulator by a simple process of inserting the cotter pin into holes and rotating the separation prevention pin.

Meanwhile, the cotter pin needs to be formed as a structure connecting high-voltage lines to maintain a stable support structure for a long period of time.

In particular, the cotter pin that is inserted into holes in a state in which the suspension insulator and the transmission/distribution wire overlap with each other has a structure in which one side is shielded by a head and the other side is secured by the separation prevention pin.

Therefore, when the state of the transmission/distribution wire changes due to environmental changes such as sunlight, rain, wind, temperature change, etc., the load applied to the head and the separation prevention pin may be relatively increased and the resulting fatigue may be accumulated. Accordingly, the cotter pin is required to have sufficient strength and durability.

### SUMMARY OF THE INVENTION

Accordingly, the present invention has been made keeping in mind the above problems occurring in the related art, and an objective of the present invention is to provide a cotter pin with a separation preventing means and a method of manufacturing the same, wherein after facilitating densification of structure by means of hot forging, shaping for securing the separation preventing means and for forming a rotation path thereof is performed by means of cold forging.

Another objective of the present invention is to provide a cotter pin with a separation preventing means and a method of manufacturing the same, wherein a dome-shaped head on each of opposite ends of a preform by means of hot forging to form a double-head shaped body and then the double-head shaped body is cut to form segmented shaped bodies, so that two cotter pins are manufactured simultaneously by a single preform forming process.

In order to achieve the above objectives, according to one aspect of the present invention, there is provided a cotter pin with a separation preventing means, the cotter pin including: a cylindrical body; a dome-shaped head formed by heating the body and pressing one end of the heated body by means of press forging; a side groove formed at each of opposite sides of a side surface of the body by means of cold forging, and formed in a shape that is recessed by a predetermined depth and extends toward the dome-shaped head from a lower end of the body opposite to the head; a lower groove formed in a lower surface of the body by means of cold forging so that lower ends of the respective side grooves are connected to each other; a through-hole formed to pass through the body so that the side grooves formed at the opposite sides of the side surface of the body are connected to each other; and a separation preventing means inserted into the through-hole and having an opening, an elastic portion, and an extension portion, the separation preventing means being configured to be rotated in response to manipulation by an operator to change between a locked state and a released state while maintaining a state coupled to the cotter pin by insertion into the through-hole.

According to another aspect of the present invention, there is provided a method of manufacturing a cotter pin with a separation preventing means, the method including: a material cutting step of forming a preform by cutting a cylindrical material to a predetermined length; a heating step of heating the preform; a first shaping step of forming a double-head shaped body by means of press forging so that a dome-shaped head is formed at each of opposite ends of the heated preform; a cutting step of cutting the double-head shaped body to form two segmented shaped bodies each of which has a predetermined length; a second shaping step of forming a side groove of a predetermined length extending from a lower end of each of the segmented shaped bodies toward the head thereof at each of opposite sides of a side surface of the segmented shaped body; a third shaping step of forming a lower groove in a lower surface of the segmented shaped body by means of forging so that lower ends of the respective side grooves formed at the opposite sides of the side surface of the segmented shaped body are connected to each other; a through-hole forming step of forming a through-hole so as to pass through the side grooves formed at the opposite sides of the side surface of the segmented shaped body; and a separation preventing means coupling step of inserting the separation preventing means into the through-hole, the separation preventing means having an opening, an elastic portion, and an extension portion, and being configured to be rotated in response to manipulation by an operator to change between a locked state and a released state while maintaining a state coupled to the cotter pin by insertion into the through-hole.

According to still another aspect of the present invention, there is provided a method of manufacturing a cotter pin with a separation preventing means, the method including: a material cutting step of forming a preform by cutting a cylindrical material to a predetermined length; a heating step of heating the preform; a first shaping step of forming a double-head shaped body by means of press forging so that a dome-shaped head is formed at each of opposite ends of the heated preform; a cutting step of cutting the double-head shaped body to form two segmented shaped bodies each of which has a predetermined length; a fourth shaping step of forming a “U”-shaped groove connecting a side surface and a lower surface of each of the segmented shaped bodies; a through-hole forming step of forming a through-hole formed to pass through opposed arms of the “U”-shaped groove from a first side to second side of the side surface of the segmented shaped body; and a separation preventing means coupling step of inserting the separation preventing means into the through-hole, the separation preventing means having an opening, an elastic portion, and an extension portion, and being configured to be rotated in response to manipulation by an operator to change between a locked state and a released state while maintaining a state coupled to the cotter pin by insertion into the through-hole.

The length of the preform may satisfy the following [Equation 1],

R>2r (wherein, R and r are positive numbers), [Equation 1]

wherein the heating step may be performed by placing a plurality of preforms resulting from cutting on top of a rail at positions spaced apart from each other and by continuously moving the preforms.

According to a cotter pin with a separation preventing means and a method of manufacturing the same, the following effects can be obtained.

After facilitating densification of structure by means of hot forging, by performing shaping for securing the separation preventing means and for forming a rotation path, by means of cold forging, it is possible to improve formability and to realize a product having a high degree of precision. Further, due to facilitating the densification of structure, it is possible to improve strength of the product, resulting in a high quality product.

Further, by forming a double-head shaped body with two heads formed by a single forging press process and by cutting the double-head shaped body into two segmented shaped bodies, it is possible to improve productivity of cotter pins.

The effects of the present invention are not limited to the above-mentioned effects, and other effects not mentioned will be clearly understood by those skilled in the art from the description of the claims.

### BRIEF DESCRIPTION OF THE DRAWINGS

FIG. 1 is view illustrating a cotter pin with a separation preventing means according to an embodiment of the present invention.

FIG. 2 is a view illustrating a configuration of the separation preventing means according to the embodiment of the present invention.

FIG. 3 is a block diagram illustrating a method of manufacturing a cotter pin with a separation preventing means according to an embodiment of the present invention.

FIG. 4 is a block diagram illustrating a method of manufacturing a cotter pin with a separation preventing means according to another embodiment of the present invention.

FIG. 5 is a flow chart illustrating the method of manufacturing the cotter pin with the separation preventing means according to the embodiment of the present invention as illustrated in FIG. 3.

FIG. 6 is a flow chart illustrating the method of manufacturing the cotter pin with the separation preventing means according to the other embodiment of the present invention as illustrated in FIG. 4.

FIG. 7 is a view illustrating an embodiment of a device configuration for heating a preform, which is a main component of the present invention.

FIG. 8 is a view illustrating a first shaping step according to the embodiment of the present invention.

FIG. 9 is a view illustrating a second shaping step according to the embodiment of the present invention.

FIG. 10 is a view illustrating a third shaping step according to the embodiment of the present invention.

FIG. 11 is a view illustrating a fourth shaping step according to the embodiment of the present invention.

FIG. 12 is a view illustrating a configuration of a suspension insulator according to the present invention.

### DETAILED DESCRIPTION OF THE INVENTION

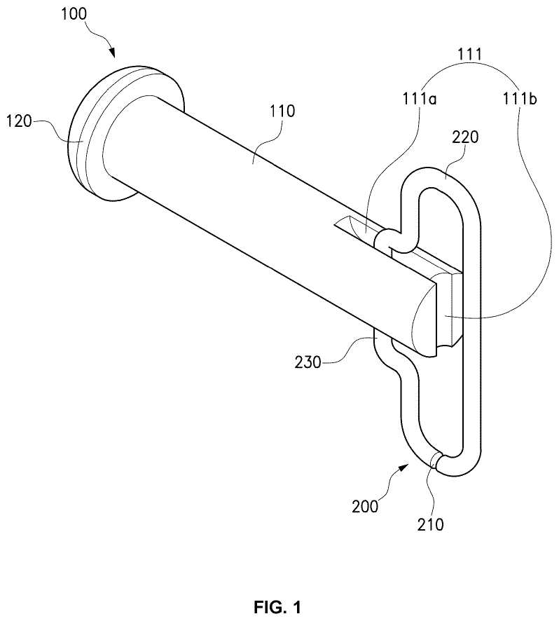

Hereinafter, exemplary embodiments of the present invention will be described in detail with reference to FIGS. 1 to 12. The illustrations and mentions of configurations and operations that can be easily understood by those in the art to which this invention belongs will be simplified or omitted. In particular, in the illustration and detailed description of the drawings, detailed descriptions and illustrations of specific technical configurations and operations of elements that are not directly related to the technical features of the present invention will be omitted, and only the technical configurations related to the present invention will be briefly illustrated or described.

Further, technical terms, as will be mentioned hereinafter, are terms defined in consideration of their function in the present invention, which may be varied according to the intention of a user, practice, or the like, so that the terms should be defined based on the contents of this specification.

As illustrated in FIG. 1, a cotter pin 100 according to an embodiment of the present invention has a shape composed of a cylindrical body 110 and a dome-shaped head 120 formed at one side of the body 110. The body 110 is configured such that a separation preventing means 200 for securing and releasing the cotter pin 100 is inserted thereinto so as to be rotatable. To this end, the body 110 has a “U”-shaped groove 111 and a through-hole 112.

The “U”-shaped groove 111 is configured to include a side groove 111a and a lower groove 111b.

The side groove 111a is provided as a pair of side grooves 111a formed at opposite sides of a side surface of the body 110, respectively. Each of the side grooves 111a is formed in a shape that is recessed in a predetermined depth so that a part of the separation preventing means 200 can be accommodated in the side groove 111a during rotation of the separation preventing means 200.

Further, the side groove 111a is formed to extend by a predetermined length from a lower end of the body 110, the lower end being opposite to the dome-shaped head 120, toward the head 120.

In this case, the length of the side groove 111a may be equal to or less than half the length of the separation preventing means 200 so that the separation preventing means 200 can be accommodated in the side groove 111a without interference during rotation.

The lower groove 111b is formed in a lower surface of each of segmented shaped bodies d1 and d2 by means of cold forging so that respective lower ends of the pair of side grooves 111a are connected to each other.

That is, the lower groove 111b forms the “U”-shaped groove 111 together with the side grooves 111a so that the separation preventing means 200 is rotated while being guided along a rotation path defined by the groove 111 and is stopped at a rotated position to be maintained in a stably secured state.

The through-hole 112 is a hole for allowing the separation preventing means 200 to be inserted thereinto and coupled to the cotter pin 100 and is formed to pass through the pair of side grooves 111a. The through-hole 112 is formed at a predetermined portion between the lower groove 111b and the dome-shaped head 120. The predetermined portion is a portion having a length that is equal to or less than a width B of an extension portion 230 of the separation preventing means 200. This ensures that the separation preventing means 200 is pressed against an inner surface of the through-hole 112 by its elastic force in a rotated state so as to be maintained in a secured state more firmly.

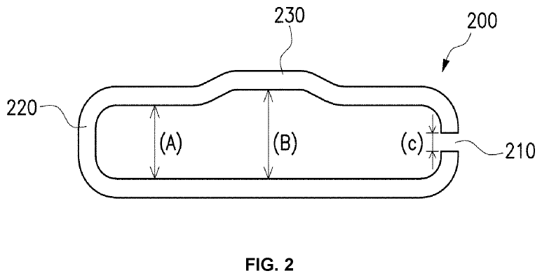

As illustrated in FIGS. 1 and 2, the separation preventing means 200 is formed by bending one wire rod and is divided into, according to the functional characteristics, an opening 210, an elastic portion 220, and the extension portion 230.

The opening 210 is a configuration for allowing the separation preventing means 200 to be inserted into the through-hole 112, and is defined by a separation distance C between parallel opposed portions of the wire rod.

The opening 210 is widened or narrowed in response to application of an external force by a user. Under conditions where no external force is applied, the opening 210 has a diameter smaller than that of the through-hole 112 so that the separation preventing means 200 that is in a state of being inserted into the through-hole 112 is prevented from being undesirably separated therefrom.

The elastic portion 220 is a bent portion where the direction of the wire rod is changed on the opposite side of the opening 210. The elastic portion 220 may be formed in a shape that is bent once as in this embodiment, but is not limited thereto. For example, the elastic portion 220 may be formed in a coil shape that is wound multiple times, and the shape thereof may be varied depending on the amount of elastic force required.

The extension portion 230 is positioned between the opening 210 and the elastic portion 220 and is formed to be bent in an outwardly expanded shape. The extension portion 230 may be formed only at either one of the parallel opposed portions of the wire rod.

The extension portion 230 formed as described above is a configuration for varying a secured position of the separation preventing means 200, and allows the separation preventing means 200 rotated in a state of being inserted into the through-hole 112 to be maintained at a secured position.

To this end, as illustrated in FIG. 2, the extension portion 230 has a shape that is bent so that the width between the parallel opposed portions of the wire rod is formed as “B”, and the width “B” is equal to the distance from the through-hole 112 to a lower end of the body 110.

The cotter pin 100 configured as described above can be stored with the separation preventing means 200 inserted in the through-hole 112, and when in use, the cotter pin 100 is inserted into an object to be secured in a state of being longitudinally aligned with the separation preventing means 200, and then the separation preventing means 200 is rotated clockwise or counterclockwise by 90° to a secured position and rotated counterclockwise or clockwise again by 90° from the secured position to a released position.

Therefore, the coupling and rotation of the separation preventing means 200 can be made more easily, and the separation preventing means 200 can be maintained in a state coupled to the cotter pin 100, which lowers the risk of loss of the separation preventing means 200.

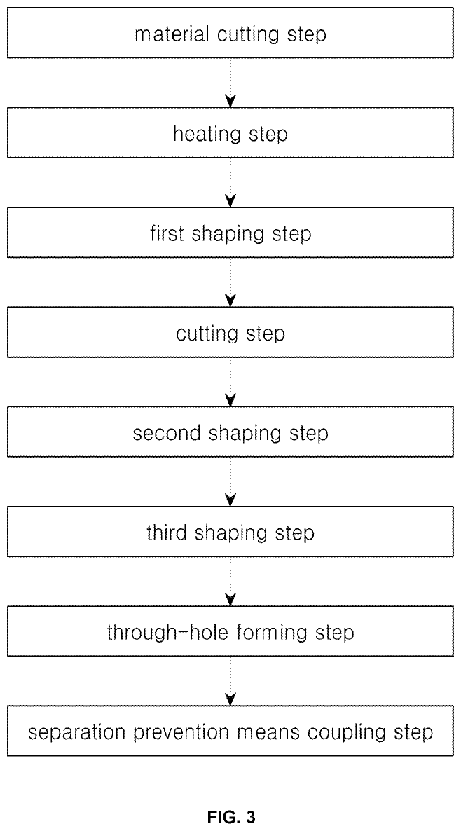

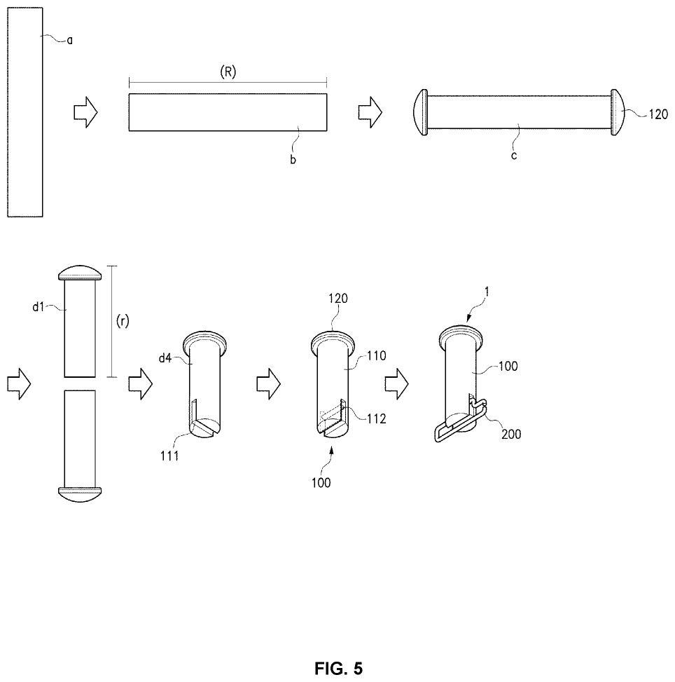

Referring to FIGS. 3 and 5, a method of manufacturing a cotter pin with a separation preventing means according to an embodiment of the present invention includes a material cutting step, a heating step, a first shaping step, a cutting step, a second shaping step, a third shaping step, a through-hole forming step, and a separation preventing means coupling step.

The material cutting step is a step of forming a preform b by cutting a cylindrical material a to a predetermined length R. The predetermined length R of the preform b has a length as represented in [Equation 1] below, which is determined in consideration of the length and machining margin of the cotter pin that is finally produced.

R>2r [Equation 1]

(wherein, R and r are positive numbers)

Here, R represents the length of the preform b, and r represents the length of each of segmented shaped bodies d1, d2, d3, and d4.

That is, the predetermined length R is determined to be larger than a combined length of each two of the segmented shaped bodies d1, d2, d3, and d4 in consideration of machining errors, and in this embodiment, is determined in a range of 134 to 140 mm and is applied to manufacture of a cotter pin of 68 to 69 mm in length.

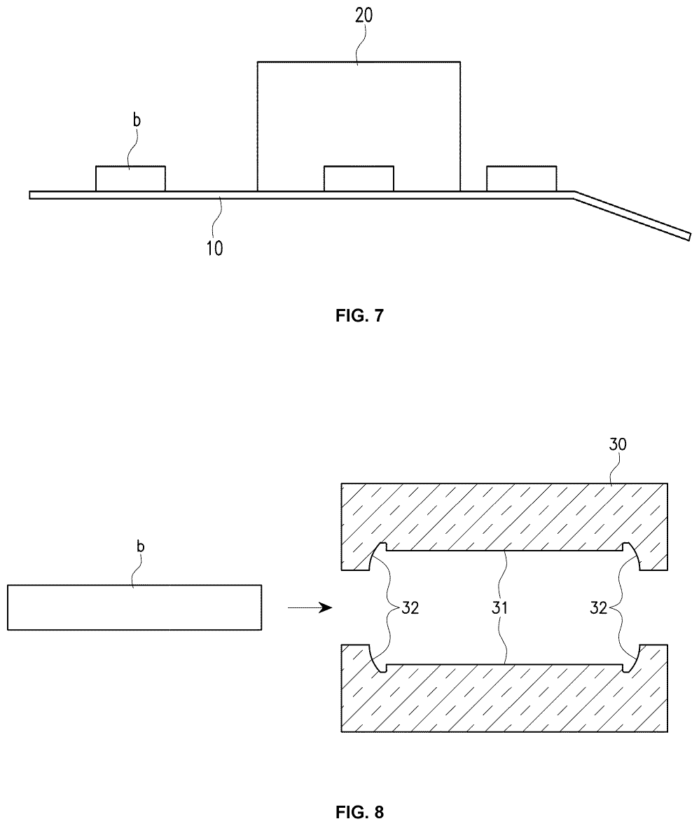

The heating step is, as illustrated in FIG. 7, a step of heating the preform b to make the preform b easy for forging. A plurality of preforms b are placed laid on their longitudinal surfaces on top of a rail 10 at positions spaced apart from each other, and are automatically continuously moved in response to the movement of the rail 10 to pass through a heating means 20.

Here, the height of the rail 10 passing through the heating means 20 may vary depending on the position of a heater of the heating means 20. That is, in a case where the heater constituting the heating means 20 is positioned in each of upper and lower portions of a heating space, the rail 10 may pass through a central portion of the heating means 20, so that the preform b conveyed along the rail 10 can be heated evenly.

On the other hand, in a case where the heater constituting the heating means 20 is provided only either in the upper or lower portion of the heating space, a material rotation function may be imparted to the rail 10 to rotate the preform b, so that the preform b can be heated evenly.

The heated preform b may be automatically seated in a double-head die 30, and alternatively may be picked up by an operator with tongs and placed in the double-head die 30.

In the heating step, heating conditions are set according to the material of the preform b.

In the embodiment of the present invention, the preform b may be made of an aluminum material, and in this case, has a heating temperature of 1100 to 1200° C. and a heating time of 5 to 15 seconds. In order to improve the mechanical properties of the material, it is necessary to set a forging end temperature higher than a recrystallization temperature of the material used. In this embodiment, a high-strength aluminum alloy for forging is used as the material for making the preform b, and a heating temperature of 1100 to 1200° C. and a heating time of 5 to 15 seconds are set as heating conditions.

Under the above heating conditions, the preform b is improved in structural density, and makes it easy to perform a subsequent shaping process.

The first shaping step is, as illustrated in FIG. 8, a step of forming a dome-shaped head 120 on the heated preform b. The heated preform b is placed inside the double-head die 30 and then pressed by upper and lower dies simultaneously to form a double-head shaped body c having a shape in which two dome-shaped heads 120 are formed at opposite ends of the heated preform b, respectively. The double-head die 30 is composed of the upper die and the lower die disposed in directions facing each other and allows the heated preform b to be shaped by a single press action. Each of the upper and lower dies of the double-head die 30 has a body groove 31 formed at a central portion of an inner surface thereof and a head groove 32 formed at each of opposite end portions of the inner surface.

The cutting step is a step of cutting the double-head shaped body c to form two segmented shaped bodies d1 each of which has a predetermined length r, and is performed after cooling the double-head shaped body c. That is, in the cutting step, the double-head shaped body c is divided into the two segmented shaped bodies d1 having the same length, and to this end, the length of the preform b is determined as described above.

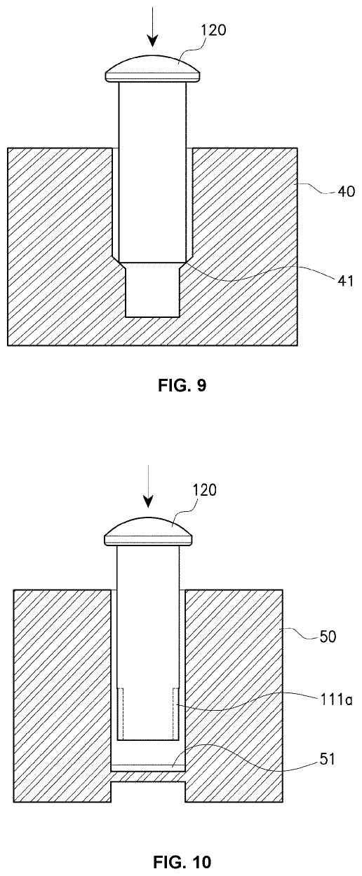

The second shaping step is, as illustrated in FIG. 9, a step of forming a side groove 111a in each of the two segmented shaped bodies d1 resulting from cutting. The side groove 111a is a groove formed to extend by a predetermined length from a lower end of the segmented shaped body d1 toward a dome-shaped head 120. The side groove 111a is formed at each of opposite sides of a side surface of the segmented shaped body d1 by means of forging with a side groove die 40. In order to form a pair of side grooves 111a, a side groove forming protrusion 41 corresponding to each of the pair of side grooves 111a is formed in the side groove die 40. The segmented shaped body d1 is inserted into the side groove die 40 from a portion opposite to the dome-shaped head 120 to an intermediate portion, followed by forging to form the pair of side grooves 111a in a recessed shape.

The third shaping step is, as illustrated in FIG. 10, a step of forming a lower groove 111b in a lower surface of a segmented shaped body d2 having the pair of side grooves 111a formed therein. The lower groove 111b is a groove formed so that respective lower ends of the pair of side grooves 111a formed in the segmented shaped body d2 are connected to each other. The lower groove 111b is formed by forging by a lower groove forming protrusion 51 formed on a lower groove die 50.

The through-hole forming step is a step of forming a through-hole 112 so as to pass through the pair of side grooves 111a in a segmented shaped body d3 having the lower groove 111b formed therein. Machining methods such as drilling, punching, and the like may be used to form the through-hole 112.

The separation preventing means coupling step is a step of inserting and assembling a separation preventing means 200 into a cotter pin 100 having the through-hole 112 formed therein. The separation preventing means 200 may be inserted into the cotter pin 100 to be rotated and secured in place.

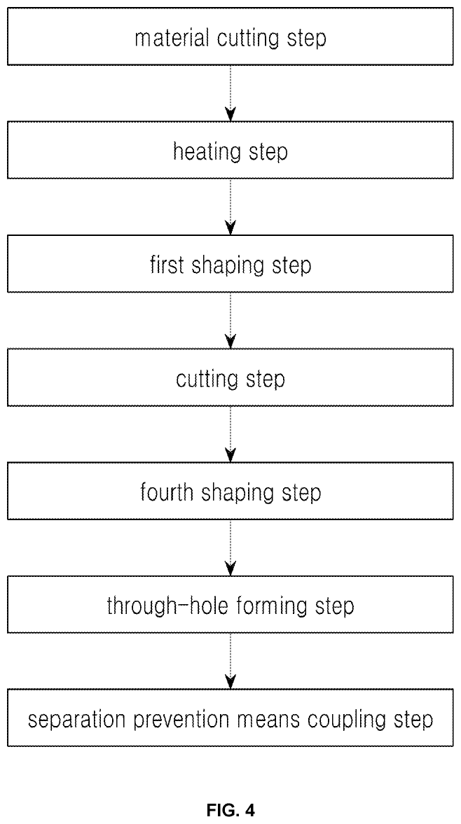

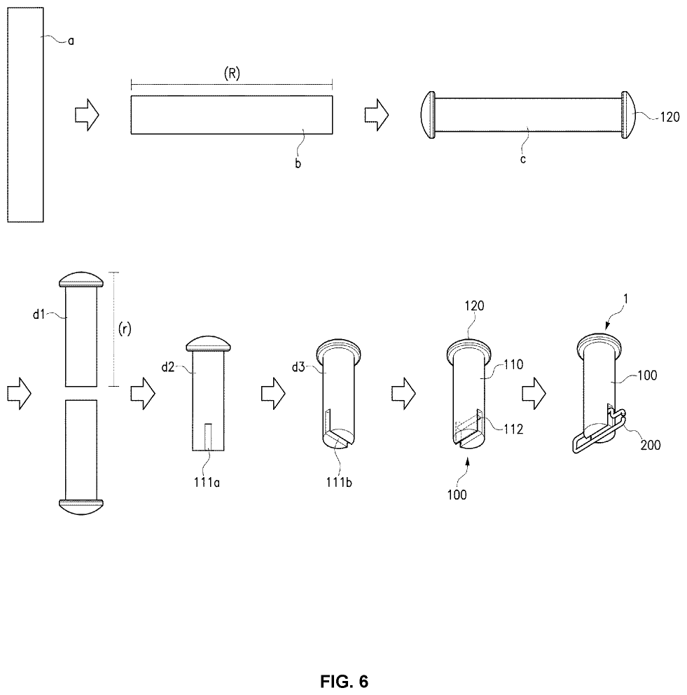

Referring to FIGS. 4 and 6, a method of manufacturing a cotter pin with a separation preventing means according to another embodiment of the present invention includes a material cutting step, a heating step, a first shaping step, a cutting step, a fourth shaping step, a through-hole forming step, and a separation preventing means coupling step.

The material cutting step, the heating step, the first shaping step, and the cutting step remain the same as the material cutting step, the heating step, the first shaping step, and the cutting step described in the previous embodiment, and thus description thereof will be omitted.

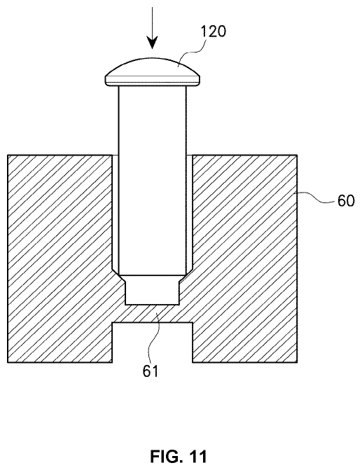

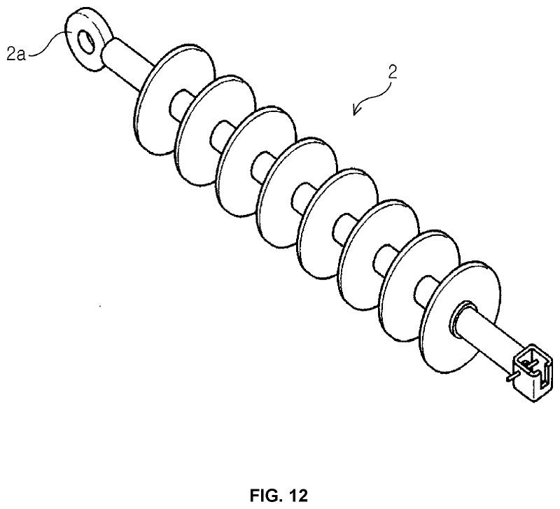

The second shaping step is, as illustrated in FIG. 11, a step of forming a “U”-shaped groove 111 in a segmented shaped body d1. The “U”-shaped groove 111 is a “U”-shaped groove including a pair of side grooves 111a and a lower groove 111b. A “U”-shaped groove die 60 allows the “U”-shaped groove 111 to be formed by means of forging by a single action. That is, the fourth shaping step is a step exerting the effect that the above-described second shaping step and the third shaping step proceed simultaneously. In order to form the “U”-shaped groove 111, a “U”-shaped groove forming protrusion 61 is formed on the “U”-shaped groove die 60. The “U”-shaped groove forming protrusion 61 has a shape in which a side groove forming protrusion 41 and a lower groove forming protrusion 51 are combined. The segmented shaped body d1 is inserted into “U”-shaped groove die 60 from a portion opposite to a dome-shaped head 120 to an intermediate portion, followed by forging to form the “U”-shaped groove 111 in a recessed shape.

The through-hole forming step is a step of forming a through-hole 112 in a segmented shaped body d4 having the “U”-shaped groove 111 formed therein so as to pass through opposed arms of the “U”-shaped groove 111. The through-hole 112 is formed to pass through the segmented shaped body d4 from a first side to a second side of a side surface thereof. Machining methods such as drilling, punching, and the like may be used to form the through-hole 112.

The separation preventing means coupling step remains the same as the above-described separation preventing means coupling step, and is a step of inserting and assembling a separation preventing means 200 into a cotter pin 100 having the through-hole 112 formed therein. The separation preventing means 200 may be inserted into the cotter pin 100 to be rotated and secured in place.

Meanwhile, in a case where the cotter pin 100 according to the present invention is needed to be inserted into a suspension insulator 2, an operator rotates the separation preventing means 200 to a released state from a locked state so that the separation preventing means 200 is longitudinally aligned with the axis of a cylindrical body 110. In this case, a separation distance A between parallel opposed portions of a wire rod is equal to the length of the through-hole 112. Therefore, the separation preventing means 200 can be easily rotated along the side grooves 111a and the lower groove 111b, and after the rotation is completed, a secured position thereof can be stably maintained.

On the other hand, in a case where the cotter pin 100 according to the present invention is needed to be secured in a locked state, the operator rotates the separation preventing means 200 from a released state to a locked state until the separation preventing means 200 reaches a position intersecting the body 110.

When the operator rotates the separation preventing means 200, the relatively narrow separation distance A between the parallel opposed portions of the wire rod is expanded during rotation, with the result that an elastic portion 220 is deformed, and when the separation preventing means 200 reaches the position intersecting the body 110, the deformed elastic portion 220 is restored to its original shape, with the result that an expansion portion 230 stably comes into contact with the lower end of the body 110.

The suspension insulator 2 is, as illustrated in FIG. 12, an insulator for transmission/distribution wires, and has to be managed to be maintained in a stably secure state. Therefore, a cotter pin 1 with the separation preventing means according to the present invention is inserted into and secured in an eye connector 2a of the suspension insulator 2. This makes it easy for the operator who works at a high altitude area to work more easily than in the case of the related art. Further, the suspension insulator 2 may employ various other connectors such as a clevis connector, a shackle, a clamp, and the like instead of the eye connector 2a.

In the cotter pin 100 manufactured integrally according to the embodiment of the present invention, the head is formed by means of hot forging. Further, since the two heads are simultaneously formed in the process of forming the head by means of hot forging and the double-head shaped body with the two heads is cut into the two segmented shaped bodies, it is possible to improve productivity of the cotter pin.

Further, in the case of the segmented shaped bodies with the heads formed thereon as described above, it is possible to improve strength by recrystallization, thus enabling a more stable securing structure of the suspension insulator to be maintained for a long period of time.

Although the exemplary embodiments of the cotter pin with the separation preventing means and the method of manufacturing the same according to the present invention have been illustrated in conjunction with the above description and drawings, the embodiments are only examples of this invention, and it will be understood by those skilled in the art that various modifications, additions and substitutions are possible, without departing from the scope and spirit of the invention as disclosed in the accompanying claims.

1. A cotter pin with a separation preventing means, the cotter pin comprising:
a cylindrical body;
a dome-shaped head formed by heating the body and pressing one end of the heated body by means of press forging;
a side groove formed at each of opposite sides of a side surface of the body by means of cold forging, and formed in a shape that is recessed by a predetermined depth and extends toward the dome-shaped head from a lower end of the body opposite to the head;
a lower groove formed in a lower surface of the body by means of cold forging so that lower ends of the respective side grooves are connected to each other;
a through-hole formed to pass through the body so that the side grooves formed at the opposite sides of the side surface of the body are connected to each other; and
a separation preventing means inserted into the through-hole and having an opening, an elastic portion, and an extension portion, the separation preventing means being configured to be rotated in response to manipulation by an operator to change between a locked state and a released state while maintaining a state coupled to the cotter pin by insertion into the through-hole.

2. A method of manufacturing a cotter pin with a separation preventing means, the method comprising:
a material cutting step of forming a preform by cutting a cylindrical material to a predetermined length (R);
a heating step of heating the preform;
a first shaping step of forming a double-head shaped body by means of press forging so that a dome-shaped head is formed at each of opposite ends of the heated preform;
a cutting step of cutting the double-head shaped body to form two segmented shaped bodies each of which has a predetermined length (r);
a second shaping step of forming a side groove of a predetermined length extending from a lower end of each of the segmented shaped bodies toward the head thereof at each of opposite sides of a side surface of the segmented shaped body;
a third shaping step of forming a lower groove in a lower surface of the segmented shaped body by means of forging so that lower ends of the respective side grooves formed at the opposite sides of the side surface of the segmented shaped body are connected to each other;
a through-hole forming step of forming a through-hole so as to pass through the side grooves formed at the opposite sides of the side surface of the segmented shaped body; and
a separation preventing means coupling step of inserting the separation preventing means into the through-hole, the separation preventing means having an opening, an elastic portion, and an extension portion, and being configured to be rotated in response to manipulation by an operator to change between a locked state and a released state while maintaining a state coupled to the cotter pin by insertion into the through-hole.

3. A method of manufacturing a cotter pin with a separation preventing means, the method comprising:
a material cutting step of forming a preform by cutting a cylindrical material to a predetermined length (R);
a heating step of heating the preform;
a first shaping step of forming a double-head shaped body by means of press forging so that a dome-shaped head is formed at each of opposite ends of the heated preform;
a cutting step of cutting the double-head shaped body to form two segmented shaped bodies each of which has a predetermined length (r);
a fourth shaping step of forming a “U”-shaped groove connecting a side surface and a lower surface of each of the segmented shaped bodies;
a through-hole forming step of forming a through-hole formed to pass through opposed arms of the “U”-shaped groove from a first side to second side of the side surface of the segmented shaped body; and
a separation preventing means coupling step of inserting the separation preventing means into the through-hole, the separation preventing means having an opening, an elastic portion, and an extension portion, and being configured to be rotated in response to manipulation by an operator to change between a locked state and a released state while maintaining a state coupled to the cotter pin by insertion into the through-hole.

4. The method of claim 2, wherein the length of the preform satisfies the following equation:
R>2r, wherein R and r are positive numbers,
wherein the heating step is performed by placing a plurality of preforms resulting from cutting on top of a rail at positions spaced apart from each other and by continuously moving the preforms.

5. The method of claim 3, wherein the length of the preform satisfies the following equation:
R>2r, wherein R and r are positive numbers,
wherein the heating step is performed by placing a plurality of preforms resulting from cutting on top of a rail at positions spaced apart from each other and by continuously moving the preforms.
